(19) United States
(12) Patent Application Publication
(10) Pub. No.: US 2022/0086632 A1
(43) Pub. Date: Mar. 17, 2022

(54) METHOD AND APPARATUS FOR SECURITY

(71) Applicant: Telefonaktiebolaget LM Ericsson (publ), Stockholm (SE)

(72) Inventor: Cheng WANG, Shanghai (CN)

(73) Assignee: Telefonaktiebolaget LM Ericsson (publ), Stockholm (SE)

(21) Appl. No.: 17/421,724

(22) PCT Filed: Jan. 14, 2019
(86) PCT No.: PCT/CN2019/071602

§ 371 Date: Jul. 8, 2021

(51) Int. Cl. H04W 12/041; H04W 12/069; H04L 29/06

(52) U.S. Cl. CPC H04W 12/041; H04L 63/0869; H04W 12/069

(57) ABSTRACT

Methods and apparatus for providing security. A method comprises deriving a key material related to an application function (AF) based on at least one key deriving input parameter and at least one share key between a network and a user equipment (UE). The method may further comprise providing the key material to an application client.

### TECHNICAL FIELD

The non-limiting and exemplary embodiments of the present disclosure generally relate to the technical field of communications, and specifically to methods and apparatuses for security.

### BACKGROUND

This section introduces aspects that may facilitate a better understanding of the disclosure. Accordingly, the statements of this section are to be read in this light and are not to be understood as admissions about what is in the prior art or what is not in the prior art.

Currently core network architecture for the fifth Generation System (5GS) such as new radio (NR) has been proposed. FIG. 1 shows a high level architecture of 5G core network (5GC). As shown in FIG. 1, 5GC may comprise a plurality of network functions (NF) such as AMF (Access and mobility Function), SMF (Session Management Function), AUSF (Authentication Service Function), UDM (Unified Data Management), PCF (Policy Control Function), AF (Application Function), NEF (Network Exposure Function), UPF (User plane Function) and NRF (NF Repository Function), etc.

5GC is designed to support a unified authentication architecture, which enable a user equipment (UE) connecting to the 5GC via different access networks, including 3rd Generation Partnership Project (3GPP) technologies, non-3GPP wireless technologies, fixed broadband access, trusted and untrusted Non-3GPP accesses, with different authentication schemes (e.g. EPS-AKA(Evolved Packet System-Authentication and Key Agreement (EPS-AKA)), EAP-AKA(Extensible Authentication Protocol-Authentication and Key Agreement), EAP-TLS(Extensible Authentication Protocol-Transport Layer Security), or any other authentication schemes.

3GPP TS33.501 V15.3.1 introduces primary authentication and key agreement procedures which enable mutual authentication between the UE and the network and provide key material that can be used between the UE and network in subsequent security procedures for different purposes, the disclosure of which is incorporated by reference herein in its entirety. On the other hand, the UEs are expected to communicate with various entities such as various AFs and/or the third party entities, for example, application servers.

### SUMMARY

This summary is provided to introduce a selection of concepts in a simplified form that are further described below in the detailed description. This summary is not intended to identify key features or essential features of the claimed subject matter, nor is it intended to be used to limit the scope of the claimed subject matter.

The 3GPP authentication infrastructure can be leveraged to enable the network and UE to establish shared keys. A typical use case is 3GPP defined Generic Bootstrapping Architecture (GBA). However, GBA based implementation has been sadly very limited in information technology (IT) industry. On the other hand, IT industry has lots of practices to leverage network/UE′ s capability to perform strong/secondary authentication for UE accessing application (APP). For example, online banking normally makes use of Short Messaging Service (SMS) as a strong authentication method to deliver a dynamic password to end user. However, clear text SMS is a target of security breach e.g. by frauding application/uniform resource locator (APP/URL), etc.

Nevertheless, it is a desire from application design to have a simple method to setup a strong and shared key material for different purposes, e.g. authentication, encryption, confidentiality, integrity check etc. It can help the application to relieve from the complexity and overhead of managing asymmetric/shared key e.g. via Public key infrastructure (PKI) or Key Management System (KMS). Therefore, there may be a need to provide an improved security solution for the application.

The present disclosure proposes a security solution, which may enable an application client and an application function to obtain key material from the UE and the network respectively. The method of some embodiments of the disclosure may leverage shared key credentials generated during UE/network authentication procedure and then derive application specific key materials and expose them for external usage, e.g. for strong authentication between an application client and an AF such as application server, encryption of communication among the application client and the AF such as application server , etc.

In a first aspect of the disclosure, there is provided a method implemented at a user equipment (UE). The method may comprise deriving a key material related to an application function (AF) based on at least one key deriving input parameter and at least one share key between a network and the UE. The method may further comprise providing the key material to an application client.

In a second aspect of the disclosure, there is provided a method implemented at an application client. The method may comprise obtaining a key material related to an application function (AF) from a user equipment (UE) or a security module of the UE, wherein the key material is derived based on at least one key deriving input parameter and at least one share key between a network and the UE. The method may further comprise applying the key material to at least one message sent and/or received by the application client.

In a third aspect of the disclosure, there is provided a method implemented at a first network function (NF). The method may comprise obtaining a key material related to an application function (AF). The key material is derived based on at least one key deriving input parameter and at least one share key between a network and a user equipment (UE). The method may further comprise providing the key material to the AF.

In a fourth aspect of the disclosure, there is provided a method implemented at a second network function (NF). The method may comprise deriving a key material related to an application function (AF) based on at least one key deriving input parameter and at least one share key between a network and a user equipment (UE). The method may further comprise providing the key material to a first NF.

In a fifth aspect of the disclosure, there is provided a method implemented at a third network function (NF). The method may comprise receiving a request or subscription from a first NF, wherein the request or subscription includes an identifier of a user equipment (UE) and at least one key deriving input parameter. The method may further comprise locating a second NF based on the identifier of the UE and the at least one key deriving input parameter. The method may further comprise sending a response including information regarding the second NF to the first NF.

In a sixth aspect of the disclosure, there is provided an apparatus implemented at a user equipment (UE). The apparatus may comprise a processor; and a memory coupled to the processor, said memory containing instructions executable by said processor, whereby said apparatus is operative to derive a key material related to an application function (AF) based on at least one key deriving input parameter and at least one share key between a network and the UE; and provide the key material to an application client.

In a seventh aspect of the disclosure, there is provided an apparatus implemented at an application client. The apparatus may comprise a processor; and a memory coupled to the processor, said memory containing instructions executable by said processor, whereby said apparatus is operative to obtain a key material related to an application function (AF) from a user equipment (UE), wherein the key material is derived based on at least one key deriving input parameter and at least one share key between a network and the UE; and apply the key material to at least one message sent and/or received by the application client.

In an eighth aspect of the disclosure, there is provided an apparatus implemented at a first network function (NF). The apparatus may comprise a processor; and a memory coupled to the processor, said memory containing instructions executable by said processor, whereby said apparatus is operative to obtain a key material related to an application function (AF), wherein the key material is derived based on at least one key deriving input parameter and at least one share key between a network and a user equipment (UE); and provide the key material to the AF.

In a ninth aspect of the disclosure, there is provided an apparatus implemented at a second network function (NF). The apparatus may comprise a processor; and a memory coupled to the processor, said memory containing instructions executable by said processor, whereby said apparatus is operative to derive a key material related to an application function (AF) based on at least one key deriving input parameter and at least one share key between a network and a user equipment (UE); and provide the key material to a first NF.

In a tenth aspect of the disclosure, there is provided an apparatus implemented at a third network function (NF). The apparatus may comprise a processor; and a memory coupled to the processor, said memory containing instructions executable by said processor, whereby said apparatus is operative to receive a request or subscription including an identifier of a user equipment (UE) and at least one key deriving input parameter from a first NF; locate a second NF based on the identifier of the UE and the at least one key deriving input parameter; and send a response including information regarding the second NF to the first NF.

In an eleventh aspect of the disclosure, there is provided a computer program product, comprising instructions which, when executed on at least one processor, cause the at least one processor to carry out the method according to the first aspect of the disclosure.

In a twelfth aspect of the disclosure, there is provided a computer program product, comprising instructions which, when executed on at least one processor, cause the at least one processor to carry out the method according to the second aspect of the disclosure.

In a thirteenth aspect of the disclosure, there is provided a computer program product, comprising instructions which, when executed on at least one processor, cause the at least one processor to carry out the method according to the third aspect of the disclosure.

In a fourteenth aspect of the disclosure, there is provided a computer program product, comprising instructions which, when executed on at least one processor, cause the at least one processor to carry out the method according to the fourth aspect of the disclosure.

In a fifteenth aspect of the disclosure, there is provided a computer program product, comprising instructions which, when executed on at least one processor, cause the at least one processor to carry out the method according to the fifth aspect of the disclosure.

In a sixteenth aspect of the disclosure, there is provided a computer-readable storage medium storing instructions which, when executed on at least one processor, cause the at least one processor to carry out the method according to the first aspect of the disclosure.

In a seventeenth aspect of the disclosure, there is provided a computer-readable storage medium storing instructions which, when executed on at least one processor, cause the at least one processor to carry out the method according to the second aspect of the disclosure.

In an eighteenth aspect of the disclosure, there is provided a computer-readable storage medium storing instructions which, when executed on at least one processor, cause the at least one processor to carry out the method according to the third aspect of the disclosure.

In a nineteenth aspect of the disclosure, there is provided a computer-readable storage medium storing instructions which, when executed on at least one processor, cause the at least one processor to carry out the method according to the fourth aspect of the disclosure.

In a twentieth aspect of the disclosure, there is provided a computer-readable storage medium storing instructions which, when executed on at least one processor, cause the at least one processor to carry out the method according to the fifth aspect of the disclosure.

In a twenty first aspect of the disclosure, there is provided an apparatus implemented at a user equipment (UE). The apparatus may comprise a deriving unit configured to derive a key material related to an application function (AF) based on at least one key deriving input parameter and at least one share key between a network and the UE; and a providing unit configured to provide the key material to an application client.

In a twenty second aspect of the disclosure, there is provided an apparatus implemented at an application client. The apparatus may comprise an obtaining unit configured to obtain a key material related to an application function (AF) from a user equipment (UE) or a security module of the UE, wherein the key material is derived based on at least one key deriving input parameter and at least one share key between a network and the UE; and an applying unit configured to apply the key material to at least one message sent and/or received by the application client.

In a twenty third aspect of the disclosure, there is provided an apparatus implemented at a first network function (NF). The apparatus may comprise a first obtaining unit configured to obtain a key material related to an application function (AF), wherein the key material is derived based on at least one key deriving input parameter and at least one share key between a network and a user equipment (UE); and a providing unit configured to provide the key material to the AF.

In a twenty fourth aspect of the disclosure, there is provided an apparatus implemented at a second network function (NF). The apparatus may comprise a deriving unit configured to deriving a key material related to an application function (AF) based on at least one key derive input parameter and at least one share key between a network and a user equipment (UE); and a providing unit configured to provide the key material to a first NF.

In a twenty fifth aspect of the disclosure, there is provided an apparatus implemented at a third network function (NF). The apparatus may comprise a first receiving unit configured to receive a request or subscription from a first NF, wherein the request or subscription includes an identifier of a user equipment (UE) and at least one key deriving input parameter; a locating unit configured to locate a second NF based on the identifier of the UE and the at least one key deriving input parameter, and a sending unit 2106 configured to sending a response including information regarding the second NF to the first NF.

The embodiments of the present disclosure may provide the following advantages. Some embodiments of the present disclosure can leverage the security material shared between network and UE generated during UE/network authentication procedure to enable an application function to have a simple method to create its own security key material, such as used for application authentication, application communication encryption. Some embodiments of the present disclosure can enable business value for mobile network operators (MNO), e.g. network exposure framework of MNO can have new business model to expose security capability of MNO and enable external applications to get different key material for their own security procedure. Some embodiments of the present disclosure can enable an automatic and genuine key material driving procedure for an application function in MNO network. The solution of embodiments of the present disclosure can be extendible for any suitable application.

### BRIEF DESCRIPTION OF THE DRAWINGS

The above and other aspects, features, and benefits of various embodiments of the present disclosure will become more fully apparent, by way of example, from the following detailed description with reference to the accompanying drawings, in which like reference numerals or letters are used to designate like or equivalent elements. The drawings are illustrated for facilitating better understanding of the embodiments of the disclosure and not necessarily drawn to scale, in which:

FIG. 1 shows a high level architecture of 5G core network;

FIG. 2 shows key hierarchy generation in 5GS;

FIG. 3 schematically shows a system according to an embodiment of the present disclosure;

FIG. 4 schematically shows a system according to another embodiment of the present disclosure;

FIG. 5 schematically shows three stages of the solution in 5GS according to an embodiment of the disclosure;

FIG. 6 shows a flowchart of a method according to an embodiment of the present disclosure;

FIG. 7 shows a flowchart of a method according to another embodiment of the present disclosure;

FIG. 8 shows a flowchart of a method according to another embodiment of the present disclosure;

FIG. 9 shows a flowchart of a method according to another embodiment of the present disclosure;

FIG. 10 shows a flowchart of a method according to another embodiment of the present disclosure;

FIG. 11 shows a flowchart of a method according to another embodiment of the present disclosure;

FIG. 12 shows a flowchart of a method according to another embodiment of the present disclosure;

FIG. 13 shows a flowchart of a method according to another embodiment of the present disclosure;

FIG. 14 shows a flowchart of a method according to another embodiment of the present disclosure;

FIG. 15 shows a flowchart of a method according to another embodiment of the present disclosure;

FIGS. 16a-16e illustrate simplified block diagrams of apparatuses according to an embodiment of the present disclosure;

FIG. 17 illustrates a simplified block diagram of an apparatus according to another embodiment of the present disclosure;

FIG. 18 illustrates a simplified block diagram of an apparatus according to another embodiment of the present disclosure;

FIG. 19 illustrates a simplified block diagram of an apparatus according to another embodiment of the present disclosure;

FIG. 20 illustrates a simplified block diagram of an apparatus according to another embodiment of the present disclosure; and

FIG. 21 illustrates a simplified block diagram of an apparatus according to another embodiment of the present disclosure.

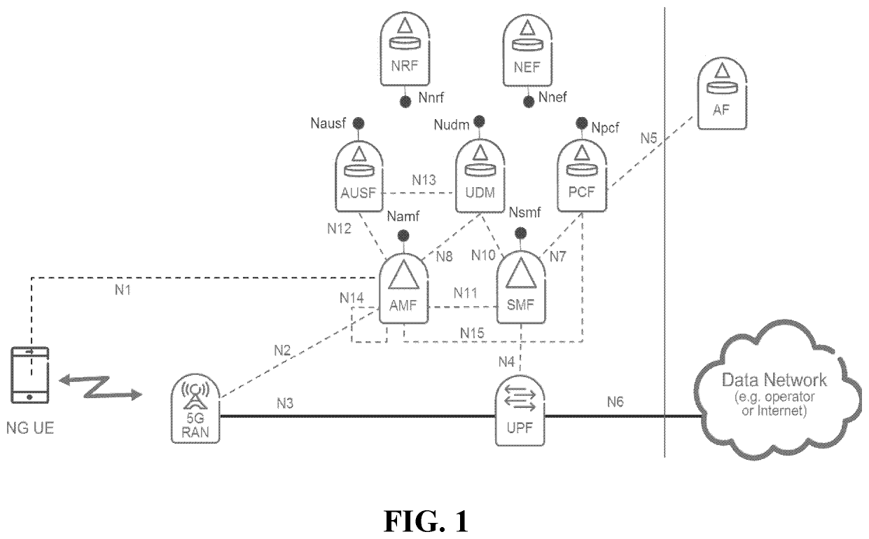

### DETAILED DESCRIPTION

The embodiments of the present disclosure are described in detail with reference to the accompanying drawings. It should be understood that these embodiments are discussed only for the purpose of enabling those skilled persons in the art to better understand and thus implement the present disclosure, rather than suggesting any limitations on the scope of the present disclosure. Reference throughout this specification to features, advantages, or similar language does not imply that all of the features and advantages that may be realized with the present disclosure should be or are in any single embodiment of the disclosure. Rather, language referring to the features and advantages is understood to mean that a specific feature, advantage, or characteristic described in connection with an embodiment is included in at least one embodiment of the present disclosure. Furthermore, the described features, advantages, and characteristics of the disclosure may be combined in any suitable manner in one or more embodiments. One skilled in the relevant art will recognize that the disclosure may be practiced without one or more of the specific features or advantages of a particular embodiment. In other instances, additional features and advantages may be recognized in certain embodiments that may not be present in all embodiments of the disclosure.

As used herein, the term “network” refers to a network following any suitable wireless/wired communication standards such as new radio (NR), long term evolution (LTE), LTE-Advanced, wideband code division multiple access (WCDMA), high-speed packet access (HSPA), Code Division Multiple Access (CDMA), Time Division Multiple Address (TDMA), Frequency Division Multiple Access (FDMA), Orthogonal Frequency-Division Multiple Access (OFDMA), Single carrier frequency division multiple access (SC-FDMA) and other wireless networks. A CDMA network may implement a radio technology such as Universal Terrestrial Radio Access (UTRA), etc. UTRA includes WCDMA and other variants of CDMA. A TDMA network may implement a radio technology such as Global System for Mobile Communications (GSM). An OFDMA network may implement a radio technology such as Evolved UTRA (E-UTRA), Ultra Mobile Broadband (UMB), IEEE 802.11 (Wi-Fi), IEEE 802.16 (WiMAX), IEEE 802.20, Flash-OFDMA, Ad-hoc network, wireless sensor network, etc. In the following description, the terms “network” and “system” can be used interchangeably. Furthermore, the communications between two devices in the network may be performed according to any suitable communication protocols, including, but not limited to, the communication protocols as defined by some of standards organizations such as 3GPP. For example, the communication protocols as defined by 3GPP may comprise the second generation (2G), third generation(3G), fourth generation (4G), 4.5G, the fourth generation (5G) communication protocols, and/or any other protocols either currently known or to be developed in the future.

The term “network device” refers to a network device in a communication network via which a terminal device accesses to the network and receives services therefrom. For example, in a wireless communication network such as a 3GPP-type cellular network, the network device may comprise access network device and core network device. For example, the access network device may comprise base station (BS), an Integrated Access and Backhaul (IAB) node, an access point (AP), a multi-cell/multicast coordination entity (MCE), etc. The BS may be, for example, a Radio Network Controller (RNC), a node B (NodeB or NB), an evolved NodeB (eNodeB or eNB), a next generation NodeB (gNodeB or gNB), a remote radio unit (RRU), a radio header (RH), a remote radio head (RRH), a relay, a low power node such as a femto, a pico, and so forth. The core network device may comprise a plurality of network devices which may offer numerous services to the customers who are interconnected by the access network device. Each access network device is connectable to the core network device over a wired or wireless connection.

The term “network function” refers to any suitable function which can be implemented in a network device of a communication network via which a terminal device can access the network and receives services therefrom. For example, the 5G communication system may comprise a plurality of NFs such as AUSF, AMF, NEF, NRF, Network Slice Selection Function (NSSF), PCF, SMF, UDM, UPF, AF, (Radio) Access Network ((R)AN), etc. In other embodiments, the network function may comprise different types of NFs for example depending on a specific type of network.

The term “terminal device” refers to any end device that can access a communication network and receive services therefrom. By way of example and not limitation, the terminal device refers to a mobile terminal, user equipment (UE), or other suitable devices. The UE may be, for example, a Subscriber Station (SS), a Portable Subscriber Station, a Mobile Station (MS), or an Access Terminal (AT). The terminal device may include, but not limited to, a portable computer, an image capture terminal device such as a digital camera, a gaming terminal device, a music storage and a playback appliance, a mobile phone, a cellular phone, a smart phone, a voice over IP (VoIP) phone, a wireless local loop phone, a tablet, a wearable device, a personal digital assistant (PDA), a portable computer, a desktop computer, a wearable terminal device, a vehicle-mounted wireless terminal device, a wireless endpoint, a mobile station, a laptop-embedded equipment (LEE), a laptop-mounted equipment (LME), a USB dongle, a smart device, a wireless customer-premises equipment (CPE) and the like. In the following description, the terms “terminal device”, “terminal”, “user equipment” and “UE” may be used interchangeably. As one example, a terminal device may represent a UE configured for communication in accordance with one or more communication standards promulgated by the 3GPP (3rd Generation Partnership Project), such as 3GPP′ LTE standard or NR standard. As used herein, a “user equipment” or “UE” may not necessarily have a “user” in the sense of a human user who owns and/or operates the relevant device. In some embodiments, a terminal device may be configured to transmit and/or receive information without direct human interaction. For instance, a terminal device may be designed to transmit information to a network on a predetermined schedule, when triggered by an internal or external event, or in response to requests from the communication network. Instead, a UE may represent a device that is intended for sale to, or operation by, a human user but that may not initially be associated with a specific human user.

As yet another example, in an Internet of Things (IOT) scenario, a terminal device may represent a machine or other device that performs monitoring and/or measurements, and transmits the results of such monitoring and/or measurements to another terminal device and/or network equipment. The terminal device may in this case be a machine-to-machine (M2M) device, which may in a 3GPP context be referred to as a machine-type communication (MTC) device. As one particular example, the terminal device may be a UE implementing the 3GPP narrow band internet of things (NB-IoT) standard. Particular examples of such machines or devices are sensors, metering devices such as power meters, industrial machinery, or home or personal appliances, for example refrigerators, televisions, personal wearables such as watches etc. In other scenarios, a terminal device may represent a vehicle or other equipment that is capable of monitoring and/or reporting on its operational status or other functions associated with its operation.

References in the specification to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the associated listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/ or combinations thereof

As used herein, a downlink, DL, transmission refers to a transmission from a network device to a terminal device, and an uplink, UL, transmission refers to a transmission in an opposite direction.

In the following description and claims, unless defined otherwise, all technical and scientific terms used herein have the same meaning as commonly understood by one of ordinary skills in the art to which this disclosure belongs.

For illustrative purposes, several embodiments of the present disclosure will be described in the context of a communication network such as SGS. Those skilled in the art will appreciate, however, that the concept and principle of the several embodiments of the present disclosure may be more generally applicable to any other suitable communication networks.

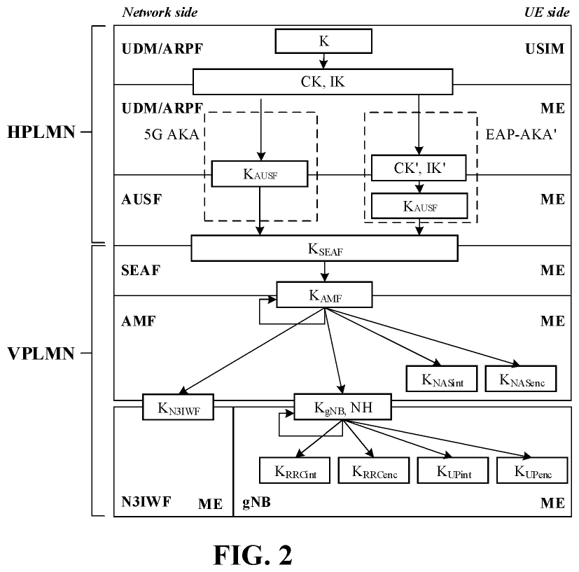

3GPP TS33.501 V15.3.1 introduces key hierarchy, key derivation, and distribution scheme. FIG. 2 shows key hierarchy generation in 5GS, which is a copy of FIG. 6.2.1-1 of 3GPP TS33.501 V15.3.1. As shown in FIG. 2, the keys related to authentication includes the following keys: K (permanent key), CK/IK (Cipher Key/Integrity Key). In case of EAP-AKA′, the keys CK′, IK′ are derived from CK, IK as specified in clause 6.1.3.1 of 3GPP TS33.501 V15.3.1. The key hierarchy includes the following keys: K_{AUSF}, K_{SEAF}, K_{AMF}, K_{NASint}, K_{NASenc}, K_{N3IWF}, K_{gNB}, K_{RRCint}, K_{RRCenc}, K_{UPint} and K_{UPenc}.

### Keys for AUSF in Home Network:

K_{AUSF} is a key derived
   by ME and AUSF from CK′, IK′ in case of EAP-AKA′, CK′ and IK′ is received by AUSF as a part of transformed AV(Authentication Vector) from ARPF(Authentication credential Repository and Processing Function); or,
   by ME and ARPF from CK, IK in case of 5G AKA, K_{AUSF} is received by AUSF as a part of the 5G HE AV(5G Home Environment Authentication Vector) from ARPF.
K_{SEAF} is an anchor key derived by ME and AUSF from K_{AUSF}. K_{SEAF} is provided by AUSF to the SEAF in the serving network.

### Key for AMF in Serving Network:

K_{AMF} is a key derived by ME and SEAF from K_{SEAF}. K_{AMF} is further derived by ME and source AMF when performing horizontal key derivation.

### Keys for NAS Signalling:

K_{NASint} is a key derived by ME and AMF from K_{AMF}, which shall only be used for the protection of NAS signalling with a particular integrity algorithm.
K_{NASenc} is a key derived by ME and AMF from K_{AMF}, which shall only be used for the protection of NAS signalling with a particular encryption algorithm.

### Key for NG-RAN(Next Generation Radio Access Network):

K_{gNB} is a key derived by ME and AMF from K_{AMF}. K_{gNB} is further derived by ME and source gNB when performing horizontal or vertical key derivation. The K_{gNB} is used as K_{eNB} between ME and ng-eNB.
   Keys for UP (user Plane) Traffic:
K_{Upenc} is a key derived by ME and gNB from K_{gNB}, which shall only be used for the protection of UP traffic with a particular encryption algorithm.
K_{UPint} is a key derived by ME and gNB from K_{gNB}, which shall only be used for the protection of UP traffic between ME and gNB with a particular integrity algorithm.
   Keys for Radio Resource Control (RRC) signalling:
K_{RRCint} is a key derived by ME and gNB from K_{gNB}, which shall only be used for the protection of RRC signalling with a particular integrity algorithm.
K_{RRcenc} is a key derived by ME and gNB from K_{gNB}, which shall only be used for the protection of RRC signalling with a particular encryption algorithm.

### Intermediate Keys:

NH is a key derived by ME and AMF to provide forward security as described in Clause A.10 of 3GPP TS33.501 V15.3.1.
K_{NG-RAN} * is a key derived by ME and NG-RAN (i.e., gNB or ng-eNB) when performing a horizontal or vertical key derivation as specified in Clause 6.9. 2.1.1 of 3GPP TS33.501 V15.3.1 using a KDF(Key Derivation Function) as specified in Clause A.11/A.12 of 3GPP TS33.501 V15.3.1.
K′_{AMF} is a key that can be derived by ME and AMF when the UE moves from one AMF to another during inter-AMF mobility as specified in Clause 6.9.3 of 3GPP TS33.501 V15.3.1 using a KDF as specified in Annex A.13 of 3GPP TS33.501 V15.3.1.

### Key for the Non-3GPP Access:

K_{N3IWF} is a key derived by ME and AMF from K_{AMF} for the non-3GPP access. K_{N3IWF} is not forwarded between N3IWFs(Non-3rd Generation Partnership Project (Non-3GPP) access InterWorking Functions).

For example, the authentication run can result in an intermediate key called the K_{AUSF}. K_{AUSF} is one of the share keys between the network and the UE, with 256bits long. The K_{AUSF} can be stored in the AUSF and UE between subsequent authentication and key agreement procedures. The usage of K_{AUSF} can be defined per operator's policy.

5GC is designed to accommodate various services e.g. massive IoT, critical communications, and enhanced mobile broadband, respectively. To allow the 3rd party/UE to access information regarding services provided by the network (e.g. connectivity information, Quality of Service (QoS), mobility, etc.) and to dynamically customize the network capability for different diverse use cases within the limits set by the operator, 5GC provides network exposure capability to enable suitable access/exchange of network information to the 3rd party or UE.

The NEF supports such exposure of capabilities of network functions, making used of the information collecting via 3GPP network internal interfaces, and exposing towards AF via proper application programming interfaces (APIs).

The NRF supports NF discovery and NF service discovery. Per 3GPP TS23.501 V15.4.0, NRF supports the following functionality:

Supports service discovery function. Receive NF Discovery Request from NF instance, and provides the information of the discovered NF instances (be discovered) to the NF instance.

Maintains the NF profile of available NF instances and their supported services.

The NF service discovery is implemented by using the NRF. The NF selection consists in selecting one NF instance among the NF instance(s) discovered during the NF service discovery. The NF selection is implemented by the requester NF, e.g. the SMF selection is supported by the AMF.

For the NRF to properly maintain the information of available NF instances and their supported services, each NF instance informs the NRF of the list of NF services that it supports and other NF instance information, which is called NF profile. The typical information of NF profile could be, as per 3GPP TS 23.501 V15.4.0:

NF instance ID (identifier)

NF type

PLMN(public land mobile network) ID

Network Slice related Identifier(s) e.g. S-NSSAI(Single—Network Slice Selection Assistance Information),

### NSI(Network Slice Instance) ID

FQDN(fully qualified domain name) or IP (Internet protocol) address of NF

NF capacity information

NF Specific Service authorization information

Names of supported services

Endpoint information of instance(s) of each supported service

Other service parameter, e.g., DNN (Data Network Name), notification endpoint for each type of notification that the NF service is interested in receiving.

etc.

It can be then seen that NF profiles holding both static and dynamic information for per NF, and a plurality of NFs and their NF profiles are stored in NRF.

As per 3GPP TS 23.502 V15.4.1, NRF can provide Nnrf_NFManagement service and Nnrf_NFDiscover service. Nnrf_NFManagement service enables NF service provider to registration its NF profile e.g. supported NF services and other NF instance information in NRF and make it available to be discovered by other NF(s). Nnrf_NFDiscover service enables NF service consumer to discover the service provided by NF service provider by querying the NRF. Depending on the requesting NF and the target NF, different input parameters is included in the discovery request then enable NRF to match a target NF best serving the requesting NF.

As used herein, the term “network key material” or “share key” refers to intermediate keys generated and shared between the network and UE during a mutual authentication procedure. The intermediate keys may comprise the keys as shown in FIG. 2, for example, K_{AUSF}, K_{SEAF}, K_{AMF}, K_{NASint}, K_{NASenc}, K_{N3IWF}, K_{gNB}, K_{RRCint}, K_{RRCenc}, K_{UPint} and K_{UPenc}. In another embodiment, the intermediate keys may comprise any other suitable keys in other communication systems. Depending on the intermediate keys' usage, the intermediate keys may be stored in UE and different NFs in the network. For example, in SGC, K_{AUSF} is stored in AUSF in HPLMN (home PLMN) and K_{SEAF} is stored in SEAF in VPLMN (visited PLMN).

As used herein, the term “key deriving input parameter” refers to the information exchange between an AF and a NF such as NEF and/or an application client and the UE or a security module of the UE, to derive an application specific key.

As used herein, the term “key material” or “exported key material” refers to an application specific key that is derived in the network and UE, and exported to the AF such as APP server and the client correspondingly. The network and UE shall use the same key deriving function to derive the key material based on the key deriving input parameter. Implementation of key deriving function can be varies depending on the different usage. The key deriving function can be, e.g. the key derivation function (KDF) specified in 3GPP TS 33.220 V15.4.0, or TLS PRF (pseudorandom function) as defined in Request For Comments (RFC) 5246 published on August, 2008.

As used herein, the term “UE API” refers to an interface and/or a procedure to derive key material based on the information stored in UE. The UE API can be provided by the UE's security module, e.g. universal integrated circuit card (UICC) which owns and stores the key material. The APP client can use the key deriving input parameter to request the key material via this API. In some embodiments, a mutual authentication and security association between the application client and the UE or the security module of the UE can be implemented in various ways and the disclosure has no limit on it.

As used herein, the term “5G SBI” refers to a service based interface (SBI) that is defined by 3GPP specification, e.g. 3GPP TS 23.501 V15.4.0, 3GPP TS 23.502 V15.4.4. For example, when UDM is concerned, this SBI refers to Nudm services provided by UDM.

As used herein, the term “exposure API” refers to the service based interfaces that is defined by 3GPP specification, e.g. 3GPP TS 23.501 V15.4.0, 3GPP TS 23.502 V15.4.1, for network exposure. In particular, it can refer to the Nnef service provided by NEF to support external exposure use cases. The mutual authentication and security association between the AF such as application server and NF such as NEF can be implemented in various ways and the disclosure has no limit on it. In an embodiment, when the NF is NEF, the exposure API may comprise NEF service API.

As used herein, the term “APP API” refers to an interface and/or a procedure that is specific to a certain application, e.g. between the AF such as application server and the application client. APP API may include the security procedure defined by the application for e.g. authentication and/or authorization. APP API also includes the application specific service procedures.

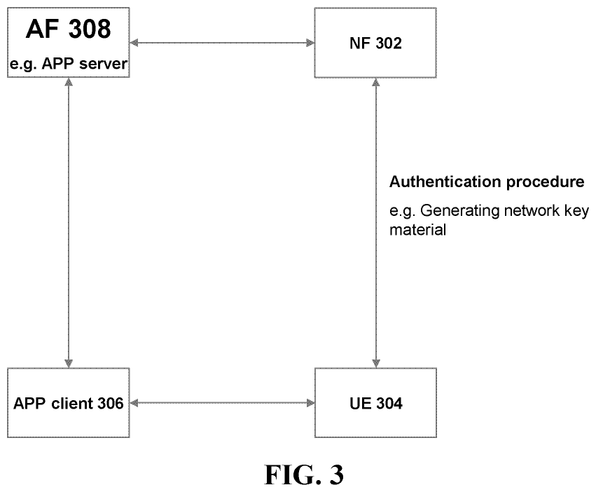

FIG. 3 schematically shows a system according to an embodiment of the present disclosure, in which some embodiments of the disclosure can be implemented. As shown in FIG. 3, the system 300 may comprise a NF 302, a UE 304, an APP client 306 and an AF 308. It is noted that though only one NF 302, one UE 304, one APP client 306 and one AF 308 are shown in FIG. 3, there may be a plurality of NFs, AFs, APP clients and UEs in other embodiments. For example, a single AF can serve one or more UEs and different AFs can serve different UEs. The AF 308 can be the AF as defined from 3GPP or any other suitable AF for example in other network such as Internet or private network. The NFs 302 may comprise various NFs for example depending on the specific type of communication network. For example, in SGS, the NFs may comprise AMF, SMF, AUSF, UDM, PCF, NEF, UPF, Binding Support Function (BSF), NRF, etc. The one or more NFs 302 and UE 304 may store at least one share key between the network and UE. For example, the UE 304 may comprise a security module which may store at least one share key between the network and UE. The APP client 306 may be located in or out of the UE 304. When the APP client 306 is not located in the UE, for example located in another entity such as another UE or a computer. In this case, an end user can access the AF such as applicable server in various ways, for example via a web portal in a personal computer client. For example, the end user can be popped up with some “bridging” methods, e.g. quick response code (QR) bar scanning, redirect uniform resource locator (URL), so that the applicable client outside the UE can also access the UE's API to get the proper key material. In addition, the application client may be the application client of the AF or another AF.

The UE 304 can run with any kind of operating system including, but not limited to, Windows, Linux, UNIX, Android, iOS and their variants. For example, the UE 304 can be a Windows/Android/iOS phone, having an app installed in it, with which the users can access the service provided by the AF 306. The service can be any kind of service including, but not limited to, news service, social networking service such as LinkedIn, Facebook, Twitter, YouTube, messaging service such as WeChat, Yahoo! Mail, and on-line shopping service such as Amazon, Alibaba, TaoBao, etc. The users can also access the service with the APP client such as a web browser, e.g. Internet Explorer, Chrome and Firefox, or other suitable applications installed in the UE 304.

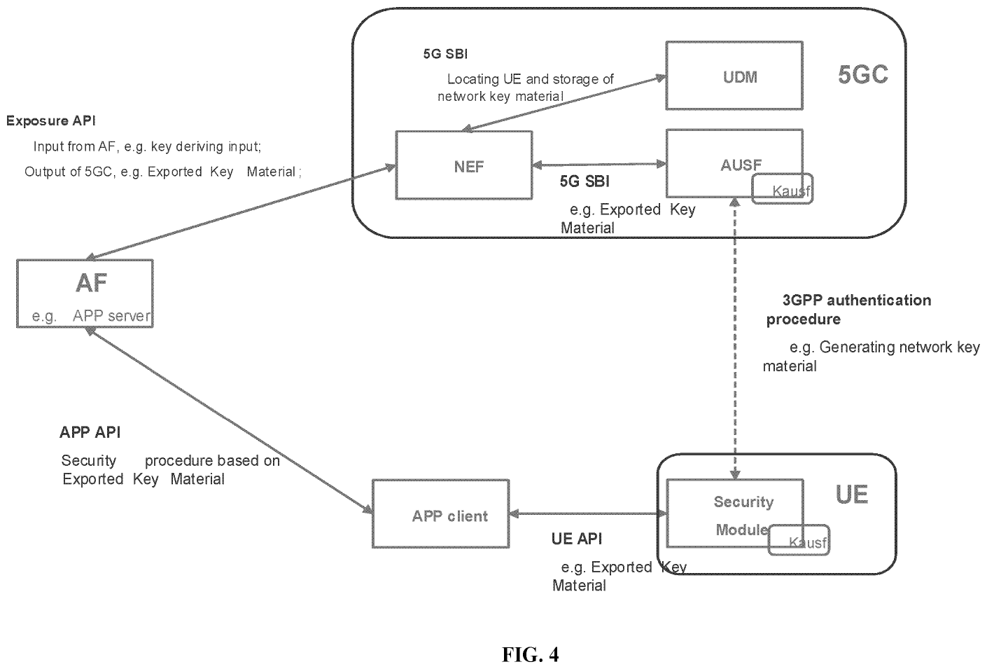

FIG. 4 schematically shows a system according to another embodiment of the present disclosure, in which some embodiments of the disclosure can be implemented. As shown in FIG. 4, the communication network is a 5GS and the NFs may comprise NFs of SGC, such as AMF, SMF, AUSF, UDM, PCF, NEF, UPF, BSF, NRF, etc. The other elements are similar to those of FIG. 3.

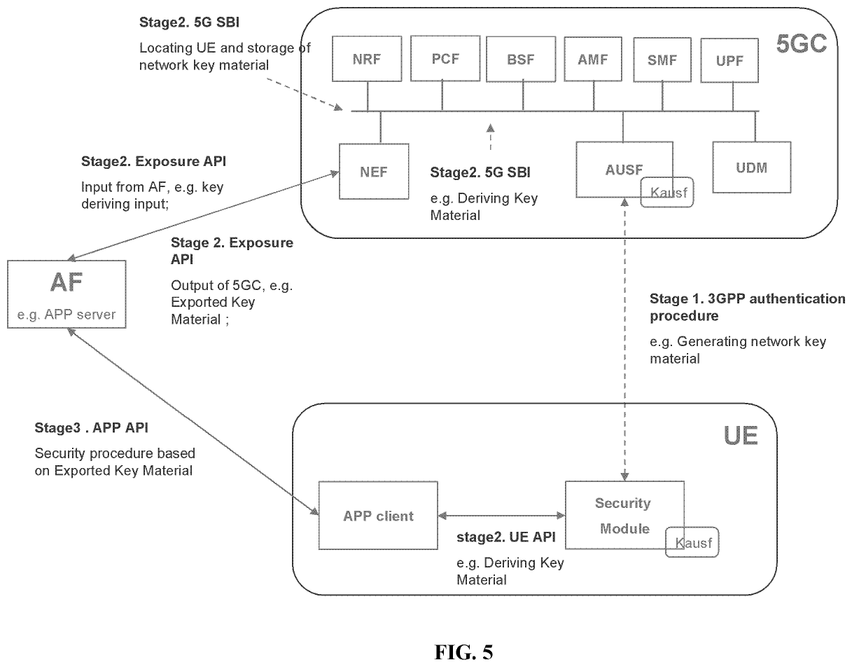

In an embodiment, the solution proposed by embodiments of the disclosure may comprise three stages. FIG. 5 schematically shows the three stages of the solution in 5GS according to an embodiment of the disclosure. As shown in FIG. 5, though the APP client is depicted as being located in the UE, the APP client can also be located outside the UE.

Stage 1 may be an authentication and key agreement procedure. For example, in 3GPP network, stage 1 may be a 3GPP authentication and key agreement procedure as shown in

FIG. 5. Stage 1 may enable mutual authentication between the UE and the network and generates key material that can be used between the UE and network in subsequent security procedures for different purposes. The key material are hence stored and maintained by the network and UE respectively. Any suitable generated key material such as K_{AUSF} can be used in the solution of the embodiments of the disclosure.

Stage 2 may refer to a procedure that an AF such as application server requests key material from the network, as well as an application client requests key material from UE. As shown in FIG. 5, in 5GS, the AF side can include the procedures involving Exposure API, 5G SBI etc. In the application client side, it can include the procedures involving UE API.

Stage 3 may refer to the procedures between the AF such as application server and the application client. It can be a security related procedure, e.g. the application server and the application client perform key establishment and setup key material for their own purposes, e.g. authentication, encryption, confidentiality, integrity check etc. It can also comprise any application specific service procedures.

Note that the procedures of stage 2 and stage 3 or the procedure triggered in the AF such as application server side and the client side can happen simultaneously and independently or correlated in order (e.g. triggered by certain APP API procedures).

FIG. 6 shows a flowchart of a method according to an embodiment of the present disclosure. In this embodiment, the communication network is a 5GS.

At step 602, the UE and the network perform 3GPP authentication procedure as defined in 3GPP TS 33.501 V15.6.1. During the 3GPP authentication procedure, network key materials are generated and stored in different NFs and the UE accordingly. These intermediate key materials are defined in 3GPP TS 33.501 V15.3.1. e.g. K_{ASUF}, K_{SEAF} etc.

At step 604, the application (APP) server requests exported key material towards the network via a network exposure service, e.g. via NEF. For example, APP server may send an exported key material request to the NEF. In addition, the APP server may send at least one key deriving input parameter accordingly, for example, in the exported key material request. In other embodiment, the NEF may prestore at least one key deriving input parameter of the APP server, in this case, the APP server may not send the at least one key deriving input parameter in the exported key material request. The association between the APP server and the UE may be identified in various ways, for example, by a user identifier, a session identifier, an address of the UE such as IP address, the UE′ profile, etc. In an embodiment, this information can be as a part of at least one key deriving input parameter.

At step 606, NEF may request Nudm service from UDM to translate an external UE identifier into a network internal identifier for example according to 3GPP TS 23.502 V15.4.1, the disclosure of which is incorporated by reference herein in its entirety. In addition, NEF may also query a relevant UE service profile from UDM. The external UE identifier can be received from the application server. For example, the external UE identifier can be as a part of at least one key deriving input parameter. The external UE identifier can be any suitable identifier which can any uniquely identify the UE, e.g. GPSI, external group identifier, etc.

The network internal UE identifier may be any suitable identifier used in the communication network. For example, in 5GS, the network internal UE identifier may comprise Subscription Permanent Identifier (SUPI), e.g. International Mobile Subscriber Identity (IMSI). The UE service profile may comprise the UE subscription information relevant for the application of the APP server, e.g. the application authorization information, including but not limited to whether or not the application can access the exposure service for that UE, whether or not an exported key is supported for that UE, which domain the key deriving is permitted, etc.

In an embodiment, when a UE IP address is received, NEF may ask 5GC NF to translate the UE IP address to a UE identifier such as GPSI, IMSI, etc. Such translation can be achieved by trigger Nbsf service on BSF to locate a PCF serving that UE and then trigger Npcf service on PCF to get the UE identifier from UE IP address as defined in 3GPP TS 23.502 V15.4.1, the disclosure of which is incorporated by reference herein in its entirety. Once NEF gets UE identifier, it can proceed with Nudm service as mentioned above.

At step 608, based on the received at least one key deriving input parameter and the fetched network internal UE identifier such as SUPI and/or the UE service profile, NEF perform a discovery procedure to locate the NF storing the network key material. NEF may use the received key deriving input parameters together with the network internal UE identifier as input and use Nnrf service to discover the NF. In this embodiment, the network key material is K_{AUSF}, the NF storing K_{AusF} is AUSF. In other embodiment, the network key material may be any other suitable key material such as K_{sEAF}, the NF may be other NF such as SEAF.

In addition, the NF such as AUSF may also use any suitable combination of at least one key deriving input parameter which it supports as input and use Nnrf service to register itself in NRF. Therefore, the NF such as AUSF can be discovered by another NF such as NEF for example based on the NF's capability supporting of at least one key deriving input parameter.

At step 610, NEF requests key material towards AUSF. For example, NEF may send an exported key material request to the AUSF. In addition, the NEF may send the at least one key deriving input parameter accordingly for example in the exported key material request.

At step 612, AUSF derives the exported key material based on the at least one key deriving input parameter and sends a response including the exported key material back to the NEF. In an embodiment, the key deriving function (KDF) is consistent in the network side and UE side. For example, a static KDF can be configured in the UE and the network for the application of the APP server. In another example, the KDF can be chosen based on for example the at least one key deriving input or a negotiation between the UE and the network. For example, the APP server and APP client can negotiate and agree the KDF selection parameters accordingly.

At step 614, NEF sends a response including the exported key material back to the APP server. Optionally, NEF may send a notification towards one or more predefined AFs, NFs and/or the UE about the completion of key deriving, to allow the one or more predefined AFs, NFs and/or UE to take any suitable actions if any.

Though steps 604, 614 and steps 610, 612 are depicted as a request/response model in FIG. 6, these steps can also be implemented in a model of subscriber/notify for example depending on a different situation. For example, the application server can subscriber an event related to the exported key material towards a NF such as NEF. When one or more new network key materials are generated within the network, the corresponding exported key material will also be generated, and then the NF such as NEF may send a notification including the corresponding exported key material towards the application server.

At step 616, the application client requests exported key material towards the UE or a security module of the UE for example via the UE API. For example, the APP client may send an exported key material request to the UE. The application client may send the at least one key deriving input parameters accordingly for example in the exported key material request.

At step 618, the UE or the security module of the UE may derive the exported key material based on the at least one key deriving input parameter and send a response including the exported key material back to the APP client. As described above, the KDF may be consistent in the network side and UE side.

Though steps 616, 618 are depicted as a request/response model in FIG. 6, these steps can also be implemented in a model of subscriber/notify for example depending on a different situation. For example, the APP client can subscriber an event related to the exported key material towards the UE or the UE's security module. Whenever one or more new network key materials are generated within the UE, the corresponding exported key material will also be generated, and then the UE or the UE's security module can send a notification including the exported key material towards the application client.

At step 620, the APP server and APP client may perform any suitable operation based on the exported key material, for example, application service setup. The any suitable operation can depend or involve the exported key material.

Steps 616-618 and steps 604-614 can happen simultaneously and independently or correlated in order.

This embodiment of the present disclosure can leverage the security material shared between network and UE generated during UE/network authentication procedure to enable an application function to have a simple method to create its own security key material, such as used for application authentication, application communication encryption. This embodiment of the present disclosure can enable business value for mobile network operators (MNO), e.g. network exposure framework of MNO can have new business model to expose security capability of MNO and enable external applications to get different key material for their own security procedure. This embodiment of the present disclosure can enable an automatic and genuine key material driving procedure for an application function in MNO network. In addition, the method can be extendible for any suitable application.

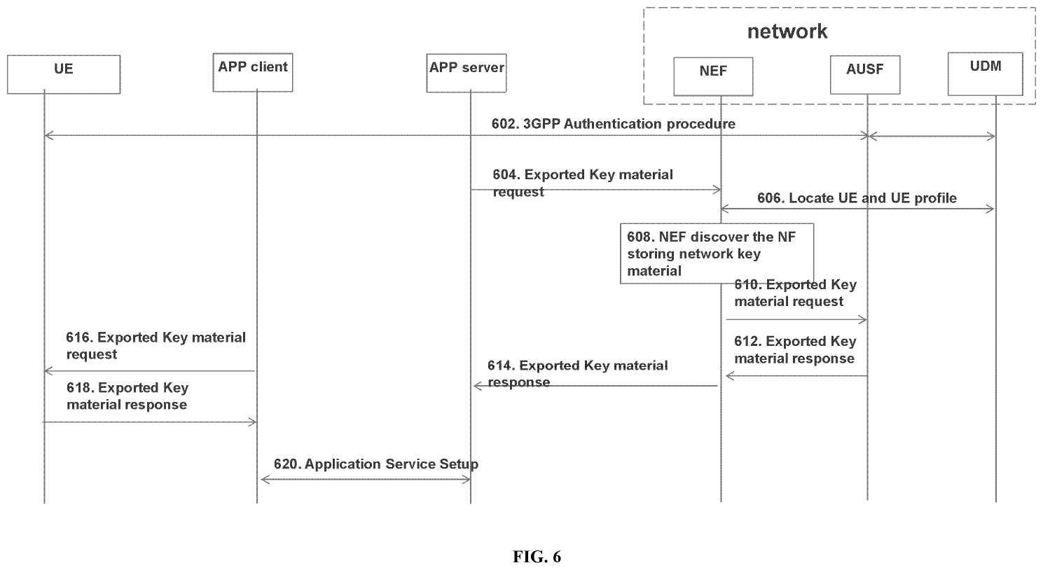

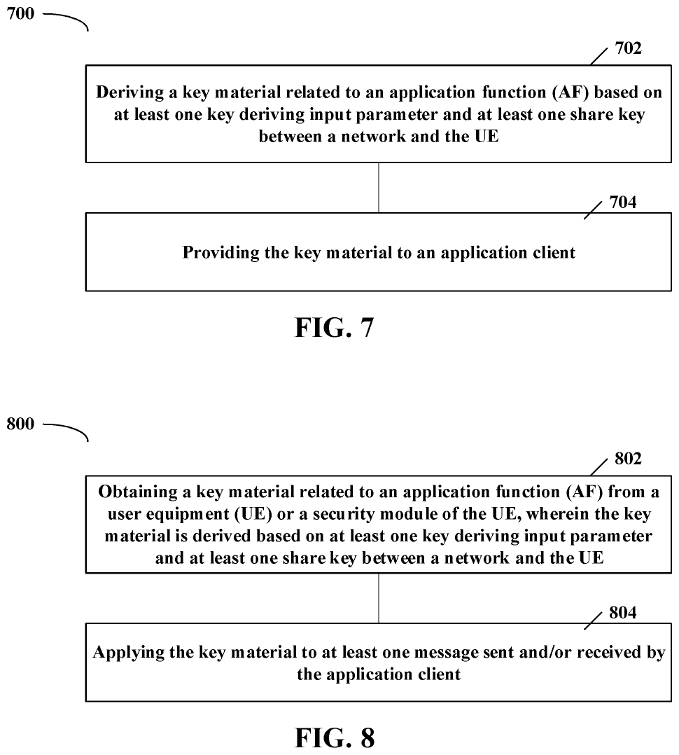

FIG. 7 shows a flowchart of a method according to another embodiment of the present disclosure, which may be performed by an apparatus implemented in a UE or communicatively coupled to a UE. As such, the apparatus may provide means for accomplishing various parts of the method 700 as well as means for accomplishing other processes in conjunction with other components. For some parts which have been described in the above embodiments, detailed description thereof is omitted here for brevity.

At block 702, the UE may derive a key material related to an AF based on at least one key deriving input parameter and at least one share key between a network and the UE. The AF may be any suitable AF. The network may be any suitable communication network. The at least one key deriving input parameter may be obtained by the UE in various ways such as explicit manner or implicit manner. For example, the at least one key deriving input parameter may be provided by an APP client or preconfigured to the UE or prestored in the UE. In another example, there may be a correspondence between the at least one key deriving input parameter and the APP client. In this case, when the UE receives a request/subscription related to the key material from the application client, it may identify the at least one key deriving input parameter related to the application client.

The at least one key deriving input parameter may comprise any suitable parameter to be used in the key deriving procedure. For example, the key deriving input parameter may comprise at least one of the AF's type, an application type, an application identifier, an user identifier (e.g. Generic Public Subscription Identifier (GPSI) or External Group Identifier), an address of the UE, an association session (e.g. APP association with UE), a context identifier, a disambiguating label string for key deriving, a random number, a key deriving domain (e.g. HPLMN, VPLMN), a key deriving function scheme (e.g. 3GPP KDF, TLS PRF(pseudorandom function)), a type of the at least one share key, a date indication, a time indication, and network specific information (e.g. Data Network Name (DNN), Network Slice Selection Assistance Information (NSSAI)), etc.

In an embodiment, the at least one share key may be generated and shared between the network and the UE during a mutual authentication procedure. Depending on the specific communication network, the number and type of the at least one share key may be different. For example, in 5GS, the at least one share key may comprise at least one of a key for the Authentication Server Function (AUSF), K_{AUSF}, a key for SEcurity Anchor Function(SEAF), K_{SEAF}, a key for Access and Mobility Management Function(AMF), K_{AMF}, a key for the protection of Non-Access Stratum (NAS) signalling with a particular integrity algorithm, K_{NASint}, a key for the protection of NAS signalling with a particular encryption algorithm, K_{NASenc}, a key for Non-3rd Generation Partnership Project (Non-3GPP) access InterWorking Function, K_{N3JWF}, a key for Next Generation Radio Access Network, K_{gNB}, a key for the protection of Radio Resource Control (RRC) signalling with a particular integrity algorithm, K_{RRCint,} a key for the protection of RRC signalling with a particular encryption algorithm, K_{RRCenc,} a key for the protection of user plane (UP) traffic with a particular encryption algorithm, K_{arim,} and a key for the protection of UP traffic between Mobile Equipment (ME) and gNB with a particular integrity algorithm, Kᵤᵣₑₙₑ.

In an embodiment, the at least one share key may be stored in a security module of the UE, such as Universal Subscriber Identity Module (USIM) or Subscriber Identity Module(SIM), etc., and the key material is derived by the security module.

In an embodiment, a same key deriving function (KDF) may be used by the network and the UE to derive the key material. For example, a static KDF can be configured for the application of the AF. In another example, the KDF can be chosen based on for example the at least one key deriving input parameter or a negotiation between the UE and the network. For example, the AF and APP client can negotiate and agree the KDF selection parameters accordingly.

In an embodiment, the KDF may be varied depending on different usage. For example, different usage may correspond to different KDF.

In an embodiment, the KDF may be selected based on the at least one key deriving input parameter. There may be a plurality of ways for using the at least one key deriving input parameter to select the KDF. For example, the value of the key deriving input parameter may be used to select the KDF. As an example, different key deriving domains may correspond to different KDFs, different key deriving function schemes may correspond to different KDFs, etc.

In an embodiment, the KDF may be selected based on a negotiation between the UE and the network. For example, the UE and the network may perform a negotiation to determine the KDF that is supported by both the network and the UE.

At block 704, the UE may provide the key material to an application client. The application client may be located in or out of the UE. For example, the application client may be installed in the UE or another entity such as another UE or a computer, etc. The application client may be the application client of the AF or another AF. When the application client is the application client of another AF, another AF can interact with the AF to obtain the key material from the AF.

In an embodiment, the UE may provide the key material to the application client in response to receiving a request or subscription from the application client. The request or subscription may include the at least one key deriving input parameter. In another embodiment, the request or subscription may not include the at least one key deriving input parameter and the UE may determine the at least one key deriving input parameter in the implicit manner as described above.

In an embodiment, when the application client is located out of the UE, the UE can provide the key material to the application client in various ways. For example, the UE and the application client can establish a connection to transmit the key material. In addition, the end user of the application client can be popped up with some “bridging” methods, e.g. QR bar scanning, redirect URL, so that the applicable client outside the UE can also access the UE's API to get the proper key material.

In one aspect, the method can leverage the security material shared between network and UE generated during UE/network authentication procedure to enable an application function to have a simple method to create its own security key material, such as used for application authentication, application communication encryption. In another aspect, the method can enable business value for mobile network operators (MNO), e.g. network exposure framework of MNO can have new business model to expose security capability of MNO and enable external applications to get different key material for their own security procedure. In another aspect, the method can enable an automatic and genuine key material driving procedure for an application function in MNO network. In addition, the method can be extendible for any suitable application.

FIG. 8 shows a flowchart of a method according to another embodiment of the present disclosure, which may be performed by an apparatus implemented in an application client or communicatively coupled to an application client. As such, the apparatus may provide means for accomplishing various parts of the method 800 as well as means for accomplishing other processes in conjunction with other components. For some parts which have been described in the above embodiments, detailed description thereof is omitted here for brevity.

At block 802, the application client may obtain a key material related to an AF from a UE or a security module of the UE, wherein the key material is derived based on at least one key deriving input parameter and at least one share key between a network and the UE. For example, the UE may provide the key material to the application client at block 704 of FIG. 7, the application client may obtain the key material from the UE.

In an embodiment, the application client may obtain the key material related to the AF from the UE in response to sending a request or subscription to the UE.

In an embodiment, the request or subscription may include the at least one key deriving input parameter.

At block 804, the application client may apply the key material to at least one message sent and/or received by the application client. For example, the at least one message may be related to a security related procedure, e.g., authentication, encryption, confidentiality, integrity check etc.

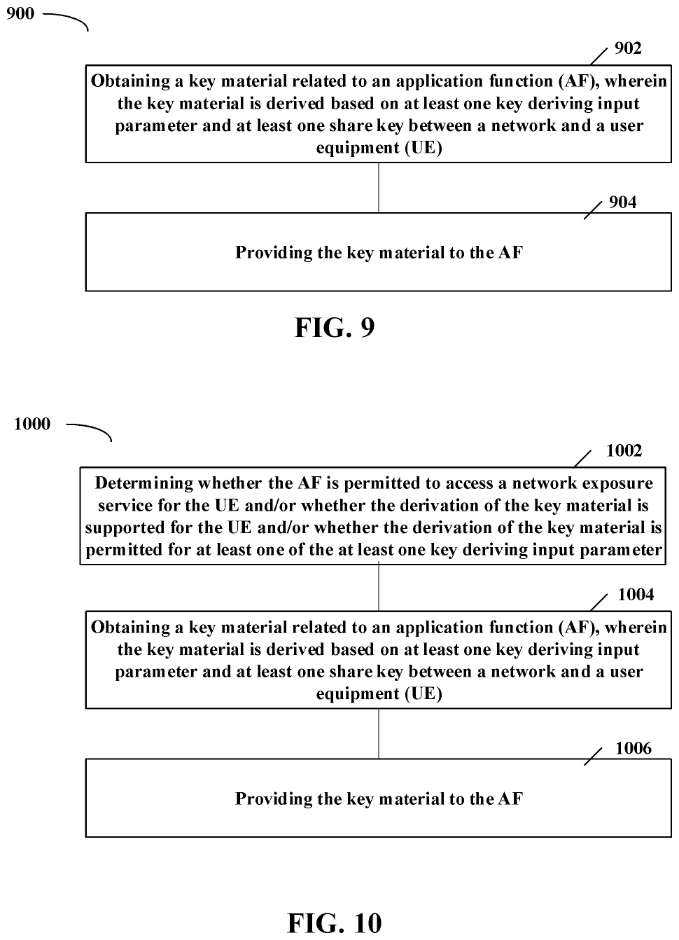

FIG. 9 shows a flowchart of a method according to another embodiment of the present disclosure, which may be performed by an apparatus implemented in a first NF or communicatively coupled to a first NF. As such, the apparatus may provide means for accomplishing various parts of the method 900 as well as means for accomplishing other processes in conjunction with other components. For some parts which have been described in the above embodiments, detailed description thereof is omitted here for brevity.

At block 902, the first NF may obtain a key material related to an AF. The key material may be derived based on at least one key deriving input parameter and at least one share key between a network and the UE. The first NF may be any suitable NF in the network which can obtain the key material. For example, the first NF may be NEF in 5GS.

The first NF may obtain the key material in various ways. For example, when the first NF may derive the key material, the first NF may obtain the key material by itself. In another example, the at least one share key may be stored in a second NF, the key material may be derived by the second NF based on the at least one key deriving input parameter and the at least one share key between the network and the UE, and the first NF may obtain the key material related to the AF from the second NF. In addition, the first NF may obtain the key material related to the AF from the second NF in response to sending a request or subscription to the second NF. The request or subscription may include the at least one key deriving input parameter.

At block 904, the first NF may provide the key material to the AF. In an embodiment, the first NF may provide the key material to the AF in response to receiving a request or subscription from the AF. The request or subscription includes the at least one key deriving input parameter

FIG. 10 shows a flowchart of a method according to another embodiment of the present disclosure, which may be performed by an apparatus implemented in a first NF or communicatively coupled to a first NF. As such, the apparatus may provide means for accomplishing various parts of the method 1000 as well as means for accomplishing other processes in conjunction with other components. For some parts which have been described in the above embodiments, detailed description thereof is omitted here for brevity.

At block 1002, the first NF may determine whether the AF is permitted to access a network exposure service for the UE and/or whether the derivation of the key material is supported for the UE and/or whether the derivation of the key material is permitted for at least one of the at least one key deriving input parameter. In an embodiment, the determination may be based on subscription information of the UE.

At block 1004, when the determination of block 1002 is positive, the first NF may obtain a key material related to an AF. Block 1004 is similar to block 902 of FIG. 9.

At block 1006, the first NF may provide the key material to the AF. Block 1006 is similar to block 904 of FIG. 9.

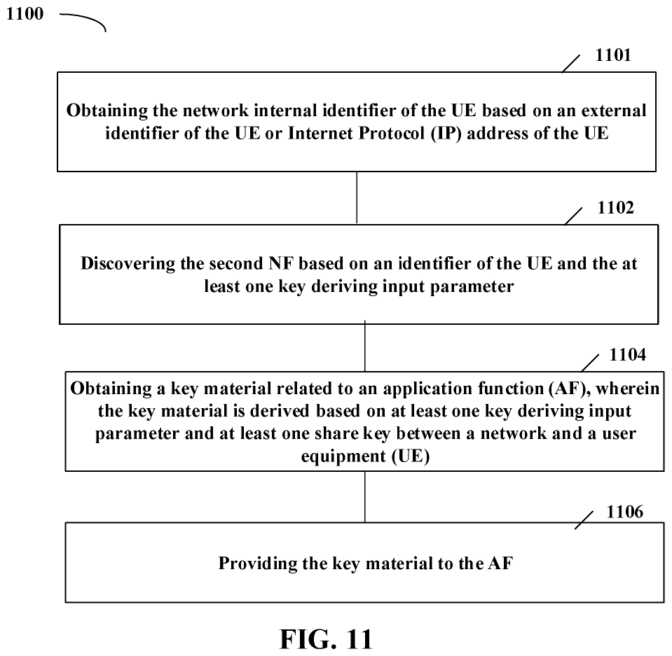

FIG. 11 shows a flowchart of a method according to another embodiment of the present disclosure, which may be performed by an apparatus implemented in a first NF or communicatively coupled to a first NF. As such, the apparatus may provide means for accomplishing various parts of the method 1000 as well as means for accomplishing other processes in conjunction with other components. For some parts which have been described in the above embodiments, detailed description thereof is omitted here for brevity. In this embodiment, the first NF obtains the key material from the second NF.

At block 1102, the first NF may discover the second NF based on an identifier of the UE and/or the at least one key deriving input parameter. For example, the first NF may use the at least one key deriving input parameter to identify which NF stores the at least one share key and use the identifier of the UE to identify the at least one share key corresponding to the UE. In an embodiment, the first NF may send a discovering request or subscription to a third NF, wherein the request or subscription includes the identifier of the UE and/or the at least one key deriving input parameter; and receive a response including information regarding the second NF from the third NF. The third NF may provide a discovery service to the first NF. For example, in SGS, the third NF may be NRF.

In an embodiment, the identifier of the UE is a network internal identifier of the UE, and the first NF may obtain the network internal identifier of the UE based on an external identifier of the UE or Internet Protocol (IP) address of the UE at block 1101. For example, in 5GS, the first NF such as NEF may request Nudm service from UDM to translate an external UE identifier into a network internal identifier for example according to 3GPP TS 23.502 V15.4.4. In other communication system, there may be similar or different translation procedure.

At block 1104, the first NF may obtain a key material related to an AF. Block 1104 is similar to block 902 of FIG. 9

At block 1106, the first NF may provide the key material to the AF. Block 1106 is similar to block 904 of FIG. 9.

In an embodiment, the first NF may comprise Network Exposure Function (NEF) and the second NF may comprise Authentication Server Function (AUSF), Access and Mobility Management Function (AMF) or SEcurity Anchor Function (SEAF), new radio Node B (gNB), Non-3GPP(3rd Generation Partnership Project) access InterWorking Function (N3IWF).

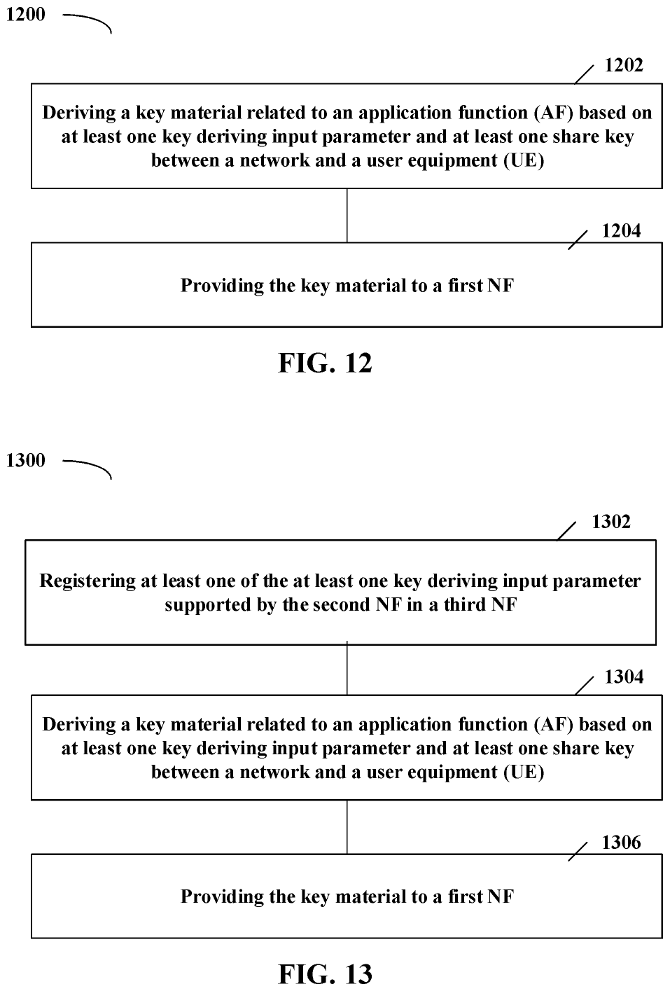

FIG. 12 shows a flowchart of a method according to another embodiment of the present disclosure, which may be performed by an apparatus implemented in a second NF or communicatively coupled to a second NF. As such, the apparatus may provide means for accomplishing various parts of the method 1200 as well as means for accomplishing other processes in conjunction with other components. For some parts which have been described in the above embodiments, detailed description thereof is omitted here for brevity.

At block 1202, the second NF may derive a key material related to an AF based on at least one key deriving input parameter and at least one share key between a network and a UE. The second NF may be any suitable NF in the network which can derive the key material. For example, the second NF may be AUSF, SEAF, etc. in 5GS. The deriving operation may be similar to those as described above.

At block 1204, the second NF may provide the key material to a first NF. In an embodiment, the second NF may provide the key material to the first NF in response to receiving a request or subscription from the first NF. The request or subscription includes the at least one key deriving input parameter.

FIG. 13 shows a flowchart of a method according to another embodiment of the present disclosure, which may be performed by an apparatus implemented in a second NF or communicatively coupled to a second NF. As such, the apparatus may provide means for accomplishing various parts of the method 1300 as well as means for accomplishing other processes in conjunction with other components. For some parts which have been described in the above embodiments, detailed description thereof is omitted here for brevity.

At block 1302, the second NF may register at least one of the at least one key deriving input parameter supported by the second NF in a third NF. The third NF may provide the discovery service to the first NF. For example, in 5GS, the third NF may be NRF.

At block 1304, the second NF may derive a key material related to an AF based on at least one key deriving input parameter and at least one share key between a network and a UE. Block 1304 is similar to block 1202 of FIG. 12.

At block 1306, the second NF may provide the key material to a first NF. Block 1306 may be similar to block 1204 of FIG. 12.

In an embodiment, the first NF may comprise Network Exposure Function (NEF) and the second NF may comprise Authentication Server Function (AUSF), Access and Mobility Management Function (AMF) or Security Anchor Function (SEAF), new radio Node B (gNB), Non-3GPP(3rd Generation Partnership Project) access InterWorking Function (N3IWF).

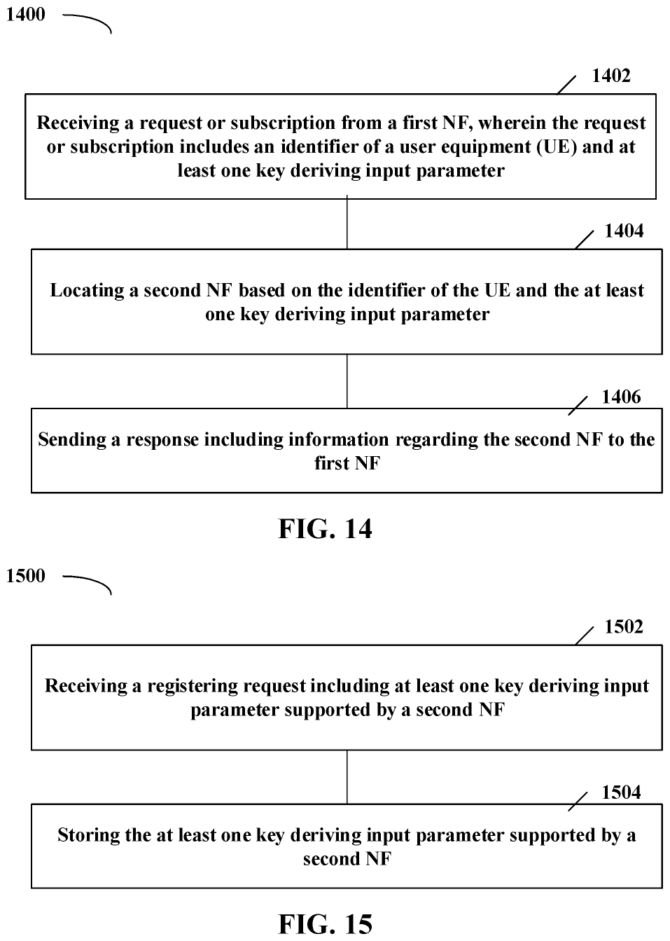

FIG. 14 shows a flowchart of a method according to another embodiment of the present disclosure, which may be performed by an apparatus implemented in a third NF or communicatively coupled to a third NF. As such, the apparatus may provide means for accomplishing various parts of the method 1400 as well as means for accomplishing other processes in conjunction with other components. For some parts which have been described in the above embodiments, detailed description thereof is omitted here for brevity.

At block 1402, the third NF may receive a request or subscription from a first NF. The request or subscription may include an identifier of a user equipment (UE) and/or at least one key deriving input parameter. The identifier of the UE and/or the at least one key deriving input parameter may be similar to those as described above.

At block 1404, the third NF may locate a second NF based on the identifier of the UE and/or the at least one key deriving input parameter. For example, the third NF may obtain the second NF profile for example from any other NF or from a registration request of the second NF. The NF profile may comprise any suitable information for example supported NF services which can make it available to be discovered by other NF(s).

At block 1406, the third NF may send a response including information regarding the second NF to the first NF.

FIG. 15 shows a flowchart of a method according to another embodiment of the present disclosure, which may be performed by an apparatus implemented in a third NF or communicatively coupled to a third NF. As such, the apparatus may provide means for accomplishing various parts of the method 1500 as well as means for accomplishing other processes in conjunction with other components. For some parts which have been described in the above embodiments, detailed description thereof is omitted here for brevity.

At block 1502, the third NF may receive a registering request including at least one key deriving input parameter supported by a second NF.

At block 1504, the third NF may store the at least one key deriving input parameter supported by a second NF.

In an embodiment, the first NF may comprise Network Exposure Function (NEF) and the second NF may comprise Authentication Server Function (AUSF), Access and Mobility Management Function (AMF) or Security Anchor Function (SEAF), new radio Node B (gNB), Non-3GPP(3^{rd} Generation Partnership Project) access InterWorking Function (N31WF) and the third NF may comprise Network-Function Repository Function.

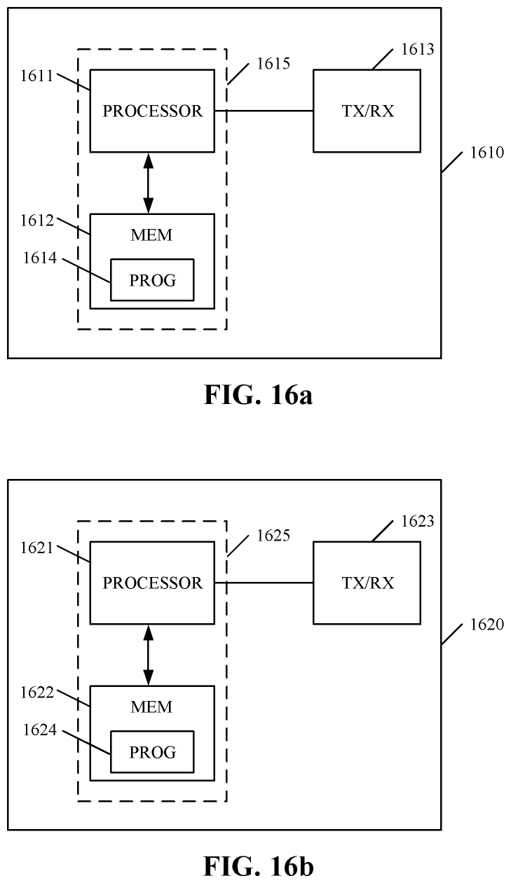

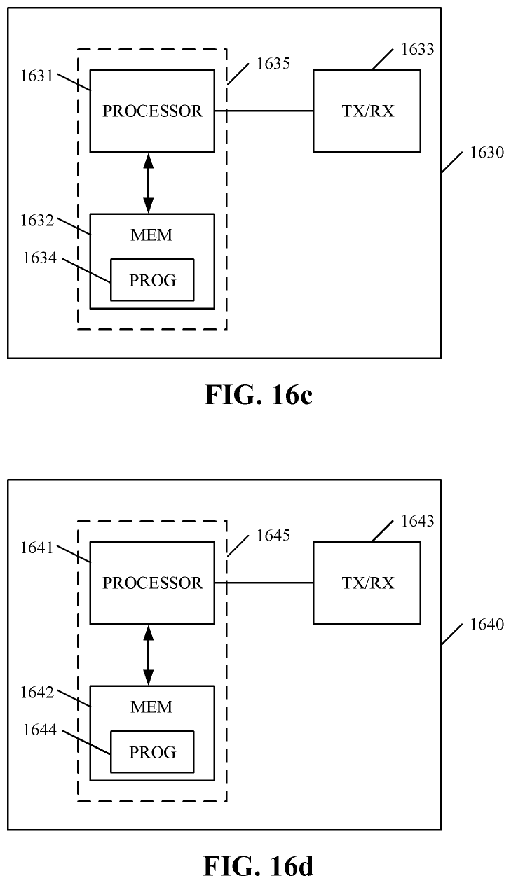

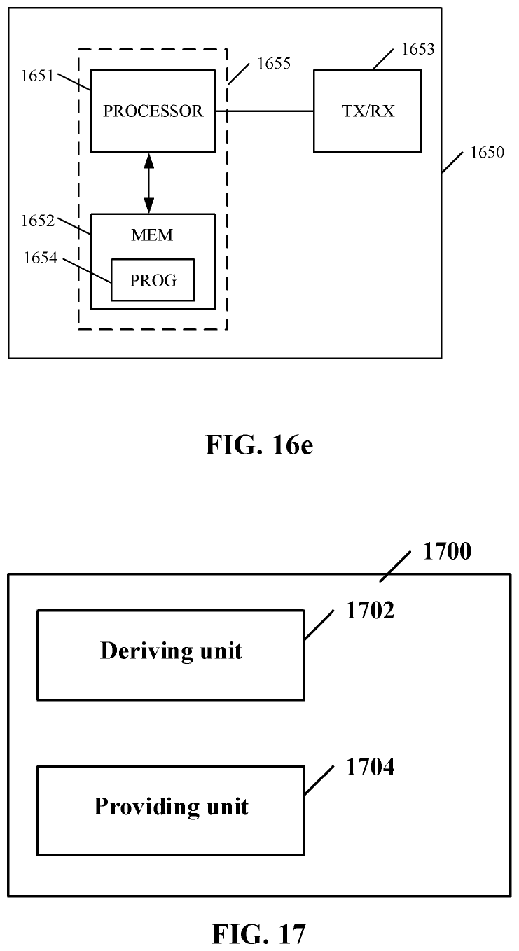

FIG. 16a illustrates a simplified block diagram of an apparatus 1610 that may be embodied in/as a UE according to an embodiment of the present disclosure. FIG. 16b illustrates an apparatus 1620 that may be embodied in/as an application client according to an embodiment of the present disclosure. FIG. 16c shows an apparatus 1630 that may be embodied in/as a first NF according to an embodiment of the present disclosure. FIG. 16d shows an apparatus 1640 that may be embodied in/as a second NF according to an embodiment of the present disclosure. FIG. 16e shows an apparatus 1650 that may be embodied in/as a third NF according to an embodiment of the present disclosure.

The apparatus 1610 may comprise at least one processor 1611, such as a data processor (DP) and at least one memory (MEM) 1612 coupled to the processor 1611. The apparatus 1610 may further comprise a transmitter TX and receiver RX 1613 coupled to the processor 1611. The MEM 1612 stores a program (PROG) 1614. The PROG 1614 may include instructions that, when executed on the associated processor 1611, enable the apparatus 1610 to operate in accordance with the embodiments of the present disclosure, for example to perform the methods 300, 400. A combination of the at least one processor 1611 and the at least one

MEM 1612 may form processing means 1615 adapted to implement various embodiments of the present disclosure.

The apparatus 1620 comprises at least one processor 1621, such as a DP, and at least one MEM 1622 coupled to the processor 1621. The apparatus 1620 may further comprise a transmitter TX and receiver RX 1623 coupled to the processor 1621. The MEM 1622 stores a PROG 1624. The PROG 1624 may include instructions that, when executed on the associated processor 1621, enable the apparatus 1620 to operate in accordance with the embodiments of the present disclosure, for example to perform the method 500. A combination of the at least one processor 1621 and the at least one MEM 1622 may form processing means 1625 adapted to implement various embodiments of the present disclosure.

The apparatus 1630 comprises at least one processor 1631, such as a DP, and at least one MEM 1632 coupled to the processor 1631. The apparatus 1630 may further comprise a transmitter TX and receiver RX 1633 coupled to the processor 1631. The MEM 1632 stores a PROG 1634. The PROG 1634 may include instructions that, when executed on the associated processor 1621, enable the apparatus 1630 to operate in accordance with the embodiments of the present disclosure, for example to perform the method 600. A combination of the at least one processor 1631 and the at least one MEM 1632 may form processing means 1635 adapted to implement various embodiments of the present disclosure.

The apparatus 1640 may comprise at least one processor 1641, such as a data processor (DP) and at least one memory (MEM) 1642 coupled to the processor 1641. The apparatus 1640 may further comprise a transmitter TX and receiver RX 1643 coupled to the processor 1641. The MEM 1642 stores a program (PROG) 1644. The PROG 1644 may include instructions that, when executed on the associated processor 1641, enable the apparatus 1640 to operate in accordance with the embodiments of the present disclosure, for example to perform the method 700. A combination of the at least one processor 1641 and the at least one MEM 1642 may form processing means 1645 adapted to implement various embodiments of the present disclosure.

The apparatus 1650 may comprise at least one processor 1651, such as a data processor (DP) and at least one memory (MEM) 1652 coupled to the processor 1651. The apparatus 1650 may further comprise a transmitter TX and receiver RX 1653 coupled to the processor 1651. The MEM 1652 stores a program (PROG) 1654. The PROG 1654 may include instructions that, when executed on the associated processor 1651, enable the apparatus 1650 to operate in accordance with the embodiments of the present disclosure, for example to perform the method 800. A combination of the at least one processor 1651 and the at least one MEM 1652 may form processing means 1655 adapted to implement various embodiments of the present disclosure.

Various embodiments of the present disclosure may be implemented by computer program executable by one or more of the processors 1611, 1621 1631, 1641 and 1651, software, firmware, hardware or in a combination thereof.

The MEMs 1612, 1622, 1632, 1642 and 1652 may be of any type suitable to the local technical environment and may be implemented using any suitable data storage technology, such as semiconductor based memory devices, magnetic memory devices and systems, optical memory devices and systems, fixed memory and removable memory, as non-limiting examples.

The processors 1611, 1621 1631, 1641 and 1651 may be of any type suitable to the local technical environment, and may include one or more of general purpose computers, special purpose computers, microprocessors, digital signal processors DSPs and processors based on multicore processor architecture, as non-limiting examples.

Reference is now made to FIG. 17, which illustrates a schematic block diagram of an apparatus 1700 for the UE. The apparatus 1700 is operable to carry out the exemplary methods related to the UE as described above.

As shown in FIG. 17, the apparatus 1700 may comprise a deriving unit 1702 configured to derive a key material related to an application function (AF) based on at least one key deriving input parameter and at least one share key between a network and the UE; and a providing unit 1704 configured to provide the key material to an application client.

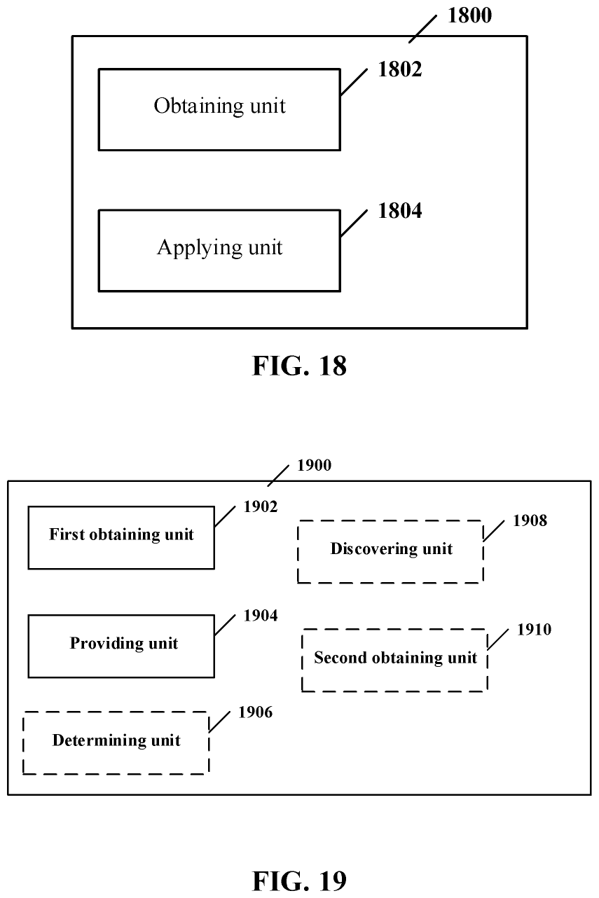

Reference is now made to FIG. 18, which illustrates a schematic block diagram of an apparatus 1800 for the applicant client. The apparatus 1800 is operable to carry out the exemplary methods related to the applicant client as described above.

As shown in FIG. 18, the apparatus 1800 may comprise an obtaining unit 1802 configured to obtain a key material related to an application function (AF) from a user equipment (UE) or a security module of the UE, wherein the key material is derived based on at least one key deriving input parameter and at least one share key between a network and the UE; and an applying unit 1804 configured to apply the key material to at least one message sent and/or received by the application client.

Reference is now made to FIG. 19, which illustrates a schematic block diagram of an apparatus 1900 for the first NF. The apparatus 1900 is operable to carry out the exemplary methods related to the first NF as described above.

As shown in FIG. 19, the apparatus 1900 may comprise a first obtaining unit 1902 configured to obtain a key material related to an application function (AF), wherein the key material is derived based on at least one key deriving input parameter and at least one share key between a network and a user equipment (UE); and a providing unit 1904 configured to provide the key material to the AF.

In an embodiment, the apparatus 1900 may further comprise a determining unit (optional) 1906 configured to determine whether the AF is permitted to access a network exposure service for the UE and/or whether the derivation of the key material is supported for the UE and/or whether the derivation of the key material is permitted for at least one of the at least one key deriving input parameter.

In an embodiment, the apparatus 1900 may further comprise a discovering unit (optional)1908 configured to discovering the second NF based on an identifier of the UE and the at least one key deriving input parameter.

In an embodiment, the apparatus 1900 may further comprise a second obtaining unit (optional)1910 configured to obtain the network internal identifier of the UE based on an external identifier of the UE or Internet Protocol (IP) address of the UE.

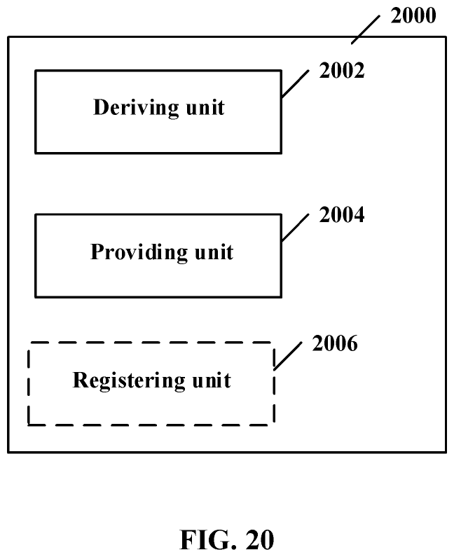

Reference is now made to FIG. 20, which illustrates a schematic block diagram of an apparatus 2000 for the second NF. The apparatus 2000 is operable to carry out the exemplary methods related to the second NF as described above.

As shown in FIG. 20, the apparatus 2000 may comprise a deriving unit 2002 configured to deriving a key material related to an application function (AF) based on at least one key derive input parameter and at least one share key between a network and a user equipment (UE); and a providing unit 2004 configured to provide the key material to a first NF.

In an embodiment, the apparatus 2000 may further comprise a registering unit (optional) 2006 configured to register at least one of the at least one key deriving input parameter supported by the second NF in a third NF.

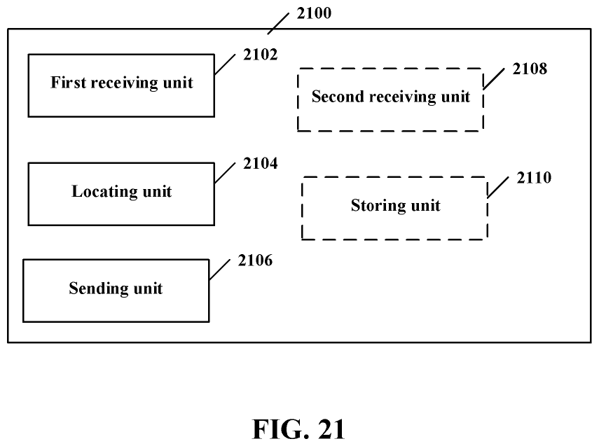

Reference is now made to FIG. 21, which illustrates a schematic block diagram of an apparatus 2100 for the third NF. The apparatus 2100 is operable to carry out the exemplary methods related to the third NF as described above.

As shown in FIG. 21, the apparatus 2100 may comprise a first receiving unit 2102 configured to receive a request or subscription from a first NF, wherein the request or subscription includes an identifier of a user equipment (UE) and at least one key deriving input parameter; a locating unit 2104 configured to locate a second NF based on the identifier of the UE and the at least one key deriving input parameter, and a sending unit 2106 configured to sending a response including information regarding the second NF to the first NF.

In an embodiment, the apparatus 2100 may further comprise a second receiving unit (optional) 2108 configured to receive a registering request including at least one key deriving input parameter supported by a second NF and a storing unit (optional) 2110 configured to store the at least one key deriving input parameter supported by a second NF.

It would be appreciated that, some units or modules in the apparatus 1700, 1800, 1900, 2000 or 2100 can be combined in some implementations. For example, in one embodiment, it is possible to use a single transceiving unit to send and receive the information.

According to an aspect of the disclosure it is provided a computer program product being tangibly stored on a computer readable storage medium and including instructions which, when executed on at least one processor, cause the at least one processor to carry out the method related to the UE as described above.

According to an aspect of the disclosure it is provided a computer program product being tangibly stored on a computer readable storage medium and including instructions which, when executed on at least one processor, cause the at least one processor to carry out the method related to the application client as described above.

According to an aspect of the disclosure it is provided a computer program product being tangibly stored on a computer readable storage medium and including instructions which, when executed on at least one processor, cause the at least one processor to carry out the method related to the first NF as described above.

According to an aspect of the disclosure it is provided a computer program product being tangibly stored on a computer readable storage medium and including instructions which, when executed on at least one processor, cause the at least one processor to carry out the method related to the second NF as described above.

According to an aspect of the disclosure it is provided a computer program product being tangibly stored on a computer readable storage medium and including instructions which, when executed on at least one processor, cause the at least one processor to carry out the method related to the third NF as described above.

In addition, the present disclosure may also provide a carrier containing the computer program as mentioned above, wherein the carrier is one of an electronic signal, optical signal, radio signal, or computer readable storage medium. The computer readable storage medium can be, for example, an optical compact disk or an electronic memory device like a RAM (random access memory), a ROM (read only memory), Flash memory, magnetic tape, CD-ROM, DVD, Blue-ray disc and the like.

The techniques described herein may be implemented by various means so that an apparatus implementing one or more functions of a corresponding apparatus described with an embodiment comprises not only prior art means, but also means for implementing the one or more functions of the corresponding apparatus described with the embodiment and it may comprise separate means for each separate function, or means that may be configured to perform two or more functions. For example, these techniques may be implemented in hardware (one or more apparatuses), firmware (one or more apparatuses), software (one or more modules), or combinations thereof. For a firmware or software, implementation may be made through modules (e.g., procedures, functions, and so on) that perform the functions described herein.

Exemplary embodiments herein have been described above with reference to block diagrams and flowchart illustrations of methods and apparatuses. It will be understood that each block of the block diagrams and flowchart illustrations, and combinations of blocks in the block diagrams and flowchart illustrations, respectively, can be implemented by various means including computer program instructions. These computer program instructions may be loaded onto a general purpose computer, special purpose computer, or other programmable data processing apparatus to produce a machine, such that the instructions which execute on the computer or other programmable data processing apparatus create means for implementing the functions specified in the flowchart block or blocks.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the subject matter described herein, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

While this specification contains many specific implementation details, these should not be construed as limitations on the scope of any implementation or of what may be claimed, but rather as descriptions of features that may be specific to particular embodiments of particular implementations. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

It will be obvious to a person skilled in the art that, as the technology advances, the inventive concept can be implemented in various ways. The above described embodiments are given for describing rather than limiting the disclosure, and it is to be understood that modifications and variations may be resorted to without departing from the spirit and scope of the disclosure as those skilled in the art readily understand. Such modifications and variations are considered to be within the scope of the disclosure and the appended claims. The protection scope of the disclosure is defined by the accompanying claims.

1-22. (canceled)

23. A method implemented at a first network function (NF), comprising:
obtaining a key material related to an application function (AF), wherein the key material is derived based on at least one key deriving input parameter and at least one share key between a network and a user equipment (UE); and
providing the key material to the AF.

24. The method according to claim 23, wherein the at least one share key is stored in a second NF, the key material is derived by the second NF based on the at least one key deriving input parameter and the at least one share key between the network and the UE, and obtaining key material related to the AF comprises:
obtaining the key material related to the AF from the second NF.

25. The method according to claim 24, wherein obtaining the key material related to the AF from the second NF is in response to sending a request or subscription to the second NF.

26. The method according to claim 25, wherein the request or subscription includes the at least one key deriving input parameter.

27. The method according to any one of claims 23 26 claim 23, further comprising
determining:
whether the AF is permitted to access a network exposure service for the UE:,
whether the derivation of the key material is supported for the UE;
whether the derivation of the key material is permitted for at least one of the at least one key deriving input parameter or
any combination thereof.

28. The method according to claim 27, wherein said determining is based on subscription information of the UE.

29. The method according to claim 24, further comprising
discovering the second NF based on an identifier of the UE or the at least one key deriving input parameter, or both the second NF based on the identifier of the UE and the at least one key deriving input parameter.

30. The method according to claim 29, wherein discovering the second NF based on the identifier of the UE or the at least one key deriving input parameter or both, comprises:
sending a discovering request or subscription to a third NF, wherein the request or subscription includes the identifier of the UE or the at least one key deriving input parameter, or both; and
receiving a response including information regarding the second NF from the third NF.

31-32. (canceled)

33. The method according to claim 23, wherein providing the key material to the AF is in response to receiving a request or subscription from the AF, wherein the request or subscription includes the at least one key deriving input parameter.

34. The method according to claim 23, wherein the at least one key deriving input parameter comprises:
the AF's type,
an application type,
an application identifier,
a user identifier,
an address of the UE,
an association session,
a context identifier,
a disambiguating label string for key deriving,
a random number,
a key deriving domain,
a key deriving function scheme,
a type of the at least one share key,
a date indication a time indication,
network specific information or
any combination thereof.

35. The method according to claim 23, wherein the at least one share key is generated and shared between the network and the UE during a mutual authentication procedure.

36. The method according to claim 23, wherein the at least one share key comprises:
a key for an Authentication Server Function (AUSF), K_{AUSF},
a key for SEcurity Anchor Function(SEAF), K_{SEAF},
a key for Access and Mobility Management Function(AMF), K_{AMF},
a key for a protection of Non-Access Stratum (NAS) signalling with a particular integrity algorithm, K_{NASint},
a key for a protection of NAS signalling with a particular encryption algorithm, K_{NASenc},
a key for Non-3rd Generation Partnership Project (Non-3GPP) access InterWorking Function, K_{N3IWF},
a key for Next Generation Radio Access Network, K_{gNB},
a key for a protection of Radio Resource Control (RRC) signalling with a particular integrity algorithm, K_{RRcint},
a key for the protection of RRC signalling with a particular encryption algorithm, K_{RRCenc},
a key for the a protection of user plane (UP) traffic with a particular encryption algorithm, K_{UPint},
a key for a protection of UP traffic between Mobile Equipment (ME) and gNB with a particular integrity algorithm, K_{UPenc}; or
any combination thereof.

37-40. (canceled)

41. A method implemented at a second network function (NF), comprising:
deriving a key material related to an application function (AF) based on at least one key deriving input parameter and at least one share key between a network and a user equipment (UE); and
providing the key material to a first NF.

42. The method according to claim 41, wherein providing the key material to the first NF is in response to receiving a request or subscription from the first NF.

43. The method according to claim 42, wherein the request or subscription includes the at least one key deriving input parameter.

44. The method according to claim 41, wherein the at least one key deriving input parameter comprises:
the AF's type,
an application type,
an application identifier,
a user identifier,
an address of the UE,
an association session,
a context identifier,
a disambiguating label string for key deriving,
a random number,
a key deriving domain,
a key deriving function scheme,
a type of the at least one share key,
a date indication a time indication,
network specific information or
any combination thereof.

45. The method according to claim 41, wherein the at least one share key is generated and shared between the network and the UE during a mutual authentication procedure.

46. The method according to claim 41, wherein the at least one share key comprises:
a key for an Authentication Server Function (AUSF), K_{AUSF},
a key for SEcurity Anchor Function(SEAF), K_{SEAF},
a key for Access and Mobility Management Function(AMF), K_{AMF},
a key for a protection of Non-Access Stratum (NAS) signalling with a particular integrity algorithm, K_{NASint},
a key for a protection of NAS signalling with a particular encryption algorithm, K_{NASenc},
a key for Non-3rd Generation Partnership Project (Non-3GPP) access InterWorking Function, K_{N3IWF},
a key for Next Generation Radio Access Network, K_{gNB},
a key for a protection of Radio Resource Control (RRC) signalling with a particular integrity algorithm, K_{RRcint},
a key for the protection of RRC signalling with a particular encryption algorithm, K_{RRCenc},
a key for the a protection of user plane (UP) traffic with a particular encryption algorithm, K_{uPint}, and
a key for a protection of UP traffic between Mobile Equipment (ME) and gNB with a particular integrity algorithm, K_{UPenc}, or
any combination thereof.

47-60. (canceled)

61. An apparatus (1630) implemented at a first network function (NF), comprising:
a processor; and
a memory coupled to the processor, said memory containing instructions which, when executed by said processor, cause said apparatus to:
obtain a key material related to an application function (AF), wherein the key material is derived based on at least one key deriving input parameter and at least one share key between a network and a user equipment (UE); and
provide the key material to the AF.

62. (canceled)

63. An apparatus implemented at a second network function (NF), comprising:
a processor; and
a memory coupled to the processor, said memory containing instructions which, when executed by said processor, cause said apparatus to:
derive a key material related to an application function (AF) based on at least one key deriving input parameter and at least one share key between a network and a user equipment (UE); and
provide the key material to a first NF.

64-68. (canceled)
